(19) United States
(12) Patent Application Publication
(10) Pub. No.: US 2013/0108785 A1
(43) Pub. Date: May 2, 2013

(54) POWDER COATING METHOD

(71) Applicants: Takayuki Okamoto, Nagoya-shi (JP); Yasuhiko Kunita, Nagoya-shi (JP); Masami Wakita, Nagoya-shi (JP)

(72) Inventors: Takayuki Okamoto, Nagoya-shi (JP); Yasuhiko Kunita, Nagoya-shi (JP); Masami Wakita, Nagoya-shi (JP)

(73) Assignee: CHUO HATSUJO KABUSHIKI KAISHA, Nagoya-shi, Aichi (JP)

(21) Appl. No.: 13/701,949

(22) PCT Filed: Apr. 1, 2011
(86) PCT No.: PCT/JP2011/058408

§ 371 Date: Dec. 4, 2012

(30) Foreign Application Priority Data
Jun. 14, 2010 (JP) 2010-134915

(51) Int. Cl. B05D 5/00

(52) U.S. Cl. CPC B05D 5/00
USPC 427/202; 427/180

(57) ABSTRACT

A powder coating method is capable of forming a coating film having excellent adhesion and surface texture by using a thermosetting powder coating material. The powder coating method is configured to include: a heating step of heating a spring member; a coating step of causing a thermosetting powder coating material to adhere to a surface of the spring member, with a surface temperature T (° C.) of the spring member being in a range of “T_{f}−20≦T<T_{f}+20” (T_{f}: a curing completion temperature (° C.) of the thermosetting powder coating material), and a curing step of curing the thermosetting powder coating material adhering to the surface of the spring member. In the curing step, the surface temperature T (° C.) of the spring member upon completion of the curing is desirably “Tₛ+30≦T” (Tₛ: a curing start temperature (° C.) of the thermosetting powder coating material).

### TECHNICAL FIELD

The present invention relates to powder coating methods capable of forming a coating film having excellent adhesion and surface texture.

### BACKGROUND ART

Various suspension springs are used for cars, railroad vehicles, etc. The surfaces of the suspension springs are normally coated in order to provide corrosion resistance. Coating methods include liquid coating using a liquid coating material and powder coating using a powder coating material. As compared to the liquid coating using water or a solvent, the powder coating is advantageous in that the coating material can be easily collected due to a small amount of scattering of the coating material, in that no environmental pollution is caused because no solvent is used, etc. In the powder coating, a coating film is normally formed by causing a charged powder coating material to electrostatically adhere to a grounded target object, and then melting and curing the powder coating material by heating.

### RELATED ART DOCUMENTS

### Patent Documents

[Patent Document 1] Japanese Patent Application Publication No. 2005-171297 (JP 2005-171297 A)
[Patent Document 2] Japanese Patent Application Publication No. H06-39344 (JP H06-39344 A)
[Patent Document 3] Japanese Patent Application Publication No. H10-314658 (JP H10-314658 A)
[Patent Document 4] Japanese Patent Application Publication No. 2002-233819 (JP 2002-233819 A)

### SUMMARY OF THE INVENTION

### Problem to be Solved by the Invention

According to the conventional method in which a powder coating material is heated after being caused to adhere to a target object, the powder coating material starts curing during a heat-up process. Accordingly, this conventional method has a problem in terms of adhesion and surface smoothness of a coating film. FIG. 4 is a schematic diagram showing a formation process of a coating film in the conventional powder coating method.

As shown in FIG. 4, a powder coating material 100a is first caused to adhere to a target object 101 (1). The target object 101 has not been heated at this point. Next, the target object 101 is heated, whereby the powder coating material 100a adhering to the target object 101 is gradually melted as the temperature rises (2). In a heat-up process, the melted powder coating material 100a enters fine projections and recesses on the surface of the target object 101. Thus, the coating film surface is smoothed (leveled), and the powder coating material 100a cures (3). After the curing is completed, cooling is performed to obtain a coating film 100b (4).

According to the conventional powder coating method, heating is started after causing the powder coating material to adhere to the target object. For example, if the heating is performed in an air-heating furnace, the powder coating material is heated from the surface side thereof. Thus, the temperature of the powder coating material rises faster at a position closer to the surface thereof. On the other hand, the temperature of the powder coating material rises more slowly on the target object side thereof than on the surface side due to heat transfer to the target object. That is, in the heat-up process, the temperature varies in the thickness direction of the powder coating material. Thus, the progress in melting and curing varies in the thickness direction of the powder coating material. This is one cause of reduction in adhesion of the coating film. Since the curing starts during the heat-up process, unevenness of the surface of the coating film tends to remain due to insufficient leveling. Thus, according to the conventional powder coating method, it is difficult to obtain a coating film having excellent adhesion and surface texture.

Patent Document 4 discloses a powder coating method for preheating a steel material as a target object to 160 to 300° C. and then sequentially coating the preheated steel material with an epoxy powder coating material and an acrylic powder coating material. Patent Document 4 describes in paragraph [0034] that coating the preheated steel material with the epoxy powder coating material improves adhesion to an acrylic coating film that is disposed on the epoxy powder coating material.

Preheating the target object can reduce a variation in temperature in the thickness direction of the powder coating material adhering to the target object. However, the preheating temperature range is too wide in the powder coating method of Patent Document 4. For example, if an epoxy thermosetting powder coating material is caused to adhere to the target object heated to a high temperature close to 300° C., the coating film surface becomes rough, and desired surface texture cannot be obtained. That is, in the case of using the thermosetting powder coating material, it is difficult to obtain a coating film with satisfactory adhesion and surface texture in the entire preheating temperature range shown above.

The present invention was developed in view of the above problems, and it is an object of the present invention to provide a powder coating method capable of forming a coating film having excellent adhesion and surface texture by using a thermosetting powder coating material.

### Means for Solving the Problem

A powder coating method of the present invention is characterized by including: a heating step of heating a spring member; a coating step of causing a thermosetting powder coating material to adhere to a surface of the spring member, with a surface temperature T (° C.) of the spring member being in a range of “T_{f}−20≦T<T_{f}+20” (T_{f}: a curing completion temperature (° C.) of the thermosetting powder coating material); and a curing step of curing the thermosetting powder coating material adhering to the surface of the spring member.

According to the powder coating method of the present invention, the spring member is preheated, and the thermosetting powder coating material is caused to adhere to the surface of the spring member while the surface temperature T (° C.) of the spring member is “T_{f}−20≦T<T_{f}+20.” As used herein, the “surface of the spring member” includes a base surface of the spring member, and in the case where a film of a phosphate such as zinc phosphate or iron phosphate is formed on the base surface of the spring member, includes the surface of the film. “T_{f}” represents the curing completion temperature of the thermosetting powder coating material (° C.). The curing completion temperature can be obtained by differential scanning calorimetry (DSC). FIG. 1 shows a schematic diagram of a DSC curve of the thermosetting powder coating material.

As shown in FIG. 1, when the thermosetting powder coating material is heated, an endothermic peak representing melting first appears. Next, an exothermic peak representing curing appears. The curing start temperature (Tₛ) and the curing completion temperature (T_{f}) of the thermosetting powder coating material can be determined from the starting and end points of the latter peak, namely the exothermic peak.

FIG. 2 shows a schematic diagram of a formation process of a coating film in the powder coating method of the present invention. As shown in FIG. 2, a spring member 21 is first heated. When the surface temperature T (° C.) of the spring member 21 reaches the range of “T_{f}−20≦T<T_{f}+20,” the heating is stopped, and coating is started. That is, a thermosetting powder coating material 20a is caused to adhere to the surface of the spring member 21 (1). After the coating is started, the surface temperature of the spring member 21 falls with time. During this period, the thermosetting powder coating material 20a adhering to the surface of the spring member 21 is melted by the remaining heat of the spring member 21, and enters fine projections and recesses on the surface of the spring member 21 (2). Thus, the coating film surface is smoothed (leveled), and the thermosetting powder coating material 20a cures (3). Thereafter, a coating film 20b is obtained by completion of the curing (4).

According to the powder coating method of the present invention, the surface temperature of the spring member is increased to a value near the curing completion temperature (T_{f}) of the thermosetting powder coating material before the coating is started. Thus, if a phosphate film is formed on the base surface of the spring member, for example, crystal water contained in the phosphate film can be evaporated. This suppresses formation of micro-blowholes in the coating film, and improves adhesion of the coating film. Since the surface temperature of the spring member is increased to a high temperature in advance, the thermosetting powder coating material adhering thereto is melted quickly. At this time, melting and curing are less likely to vary in the thickness direction of the thermosetting powder coating material. Moreover, the melted thermosetting powder coating material has relatively low viscosity. Accordingly, the thermosetting powder coating material easily spreads on the surface of the spring member, and quickly enters the fine projections and recesses on the surface of the spring member. Thus, the coating film surface is easily smoothed. Moreover, the curing time is reduced.

As described above, according to the powder coating method of the present invention, a coating film having high adhesion and having excellent surface texture and good appearance can be formed. Moreover, since the curing time can be reduced, production efficiency can be improved.

### BRIEF DESCRIPTION OF THE DRAWINGS

FIG. 1 is a schematic diagram of a DSC curve of a thermosetting powder coating material.

FIG. 2 is a schematic diagram of a formation process of a coating film in a powder coating method of the present invention.

FIG. 3 is a schematic diagram showing change in surface temperature of a spring member with time in the powder coating method of the present invention.

FIG. 4 is a schematic diagram of a formation process of a coating film in a conventional powder coating method.

FIG. 5 shows an image of a coating film of an example before a salt spray test.

FIG. 6 shows an enlarged image of a rusted part of the coating film surface of the example after 720 hours of the salt spray test.

FIG. 7 shows an image of a coating film of a comparative example before a salt spray test.

FIG. 8 is an enlarged image of a rusted part of the coating film surface of the comparative example after 720 hours of the salt spray test.

### DESCRIPTION OF THE REFERENCE NUMERALS

20a: thermosetting powder coating material
20b: coating film
21: spring member
100a: powder coating material
100b: coating film
101: target object

### MODES FOR CARRYING OUT THE INVENTION

An embodiment of a powder coating method of the present invention will be described below. The powder coating method of the present invention is not limited to the following embodiment, and may be embodied in various forms based on modifications, improvements, etc. that may be made by those skilled in the art without departing from the spirit and scope of the present invention.

The powder coating method of the present invention includes a heating step, a coating step, and a curing step. These steps will be described in order below.

(1) Heating Step

This step is the step of heating a spring member. The type of spring member is not particularly limited. Various spring members such as a coil spring, a leaf spring, a torsion bar, and a stabilizer bar can be used. The material of the spring member is not particularly limited as long as it is a metal. Spring steel etc. that is commonly used for springs is preferred. For example, after the spring steel etc. is hot-formed or cold-formed, the spring member can be subjected to shot peening or the like to adjust surface roughness thereof.

It is desirable to form a film of a phosphate such as zinc phosphate or iron phosphate on the base surface of the spring member. In this case, the powder coating method of the present invention may be configured to include, before this step, a pretreatment step of forming in advance a phosphate film on the base surface of the spring member. Forming a coating film on the phosphate film improves corrosion resistance and adhesion of the coating film. In this case, it is effective for the phosphate film to cover 80% or more of the area of the coating surface of the spring member. In particular, the corrosion resistance is further improved in the case where the phosphate is zinc phosphate.

The phosphate film can be formed by known methods. For example, the phosphate film can be formed by an immersion method of immersing the spring member in a phosphate solution bath, a spray method of spraying a phosphate solution onto the spring member with a spray gun, etc.

Coating mass of the phosphate film formed is not particularly limited.

Typically, coating mass of about 1.8 to 2.3 g/m² is required in order to provide corrosion resistance by the phosphate film. On the other hand, the smaller the coating mass is, the higher the adhesion of the film is. Accordingly, in view of the adhesion of the coating film, the coating mass can be 2.2 g/m² or less. The coating mass can be obtained by measuring the mass of the formed film. If the coating film is formed by the spray method, the coating mass can be obtained by calculation based on the discharge rate of the spray gun.

For example, crystals of zinc phosphate in the phosphate film are formed by Zn₃(PO₄)₂.4H₂O (orthorhombic crystals) and Zn₂Fe(PO₄)₂.4H₂O (monoclinic crystals). Such a shape and size of the crystals of the phosphate also affect corrosion resistance and adhesion of the coating film. In order to further improve corrosion resistance and adhesion, the crystal shape of the phosphate is desirably close to a spherical shape, and the mean diameter of the crystals is 3 μm or less. The mean diameter of the crystals can be measured by observing the phosphate film with a scanning electron microscope (SEM) etc. In this specification, the mean value of the major axis of the crystals observed by the SEM is used as the mean diameter.

The heating method of the spring member is not particularly limited. For example, the spring member may be accommodated and heated in an air-heating furnace, a far-infrared furnace, or the like. The spring member may be heated by electrical heating or induction heating. Especially, the electrical heating is preferable because it has high heat efficiency, is capable of heating the spring member with any shape, etc.

In this step and the subsequent coating and curing steps, the surface temperature of the spring member can be measured by using a non-contact thermometer such as a thermograph, for example.

(2) Coating Step

This step is the step of causing the thermosetting powder coating material to adhere to the surface of the spring member, with the surface temperature T (° C.) of the heated spring member being in the range of “T_{f}−20≦T≦T<T_{f}+20” (T_{f′}: curing completion temperature (° C.) of the thermosetting powder coating material).

In this step, the heating is stopped when the surface temperature T of the spring member reaches “T_{f}−20≦T<T_{f}+20.” Then, the thermosetting powder coating material is caused to adhere to the surface of the spring member. A method that is commonly used for powder coating, such as an electrostatic coating method, an electrostatic fluidized immersion method, or a fluidized immersion method, may be used to cause the thermosetting powder coating material to adhere to the surface of the spring member, namely, to perform coating.

If the surface temperature of the spring member is less than “T_{f}−20” (° C.), it is difficult to cause curing to sufficiently proceed using the remaining heat of the spring member. Moreover, due to high viscosity of the melted thermosetting powder coating material, the melted thermosetting powder coating material does not easily spread on the surface of the spring member, and unevenness of the coating film surface may remain. On the contrary, if the surface temperature of the spring member is equal to or higher than “T_{f}+20” (° C.), the coating film surface becomes rough, and desired surface texture cannot be obtained.

The thermosetting powder coating material to be used primarily contains, as a base of coating film formation, a base resin, a curing agent, and a pigment. Examples of the base resin include an epoxy resin, a polyester resin, and the like. In order to further improve corrosion resistance, it is desirable that the thermosetting powder coating material contain an epoxy resin. In view of weather resistance, a mode is preferred in which the thermosetting powder coating material contains an epoxy resin and a polyester resin. In this mode, curing proceeds according to the reaction between the polyester resin and the epoxy resin. That is, the polyester resin serves as a base resin, and the epoxy resin serves as a curing agent. The blending ratio of the epoxy resin to the polyester resin is not particularly limited. However, for example, it is desirable that the equivalent ratio of the epoxy resin to the polyester resin be 1:1.

Examples of the epoxy resin include a bisphenol A epoxy resin, a bisphenol F epoxy resin, a crystalline epoxy resin, and the like. Examples of the polyester resin include a resin produced by a transesterification or polycondensation reaction between a polyhydric alcohol, such as ethylene glycol, diethylene glycol, triethylene glycol, propanediol, butanediol, pentanediol, and hexanediol, and a carboxylic acid, such as terephthalic acid, maleic acid, isophthalic acid, succinic acid, adipic acid, and sebacic acid. One of these resins may be used solely, or a mixture of two or more of them may be used.

Examples of the curing agent include an aromatic amine, an acid anhydride, a derivative of dicyandiamide, a derivative of organic acid dihydrazide, a phenol resin, and the like.

As the pigment, examples of a color pigment include an inorganic pigment such as carbon black, titanium dioxide, red iron oxide, ocher, and the like, and an organic pigment such as quinacridone red, phthalocyanine blue, and benzidine yellow. Examples of an extender include calcium carbonate, magnesium carbonate, talc, silica, barium sulfate, and the like. In particular, the extender is important because it affects mechanical characteristics of the coating film. For example, if particles forming the extender have a small particle size, flexibility or the like of the coating film is improved. Accordingly, if calcium carbonate is used as the extender, for example, it is desirable that the mean particle diameter of the extender be about 0.5 μm. Moreover, impact resistance or the like of the coating film varies depending on the particle shape such as a scale shape, an irregular shape, or a needle shape. In order to improve the impact resistance of the coating film, it is desirable to use an extender having a needle shape or irregular shape.

The content of the pigment in the thermosetting powder coating material is not particularly limited. However, in view of the hiding property, for example, it is desirable that the coating material contain 2 mass % or more of the pigment when the overall mass of the coating material is 100 mass %. On the other hand, in view of dispersibility of the pigment, it is desirable that the coating material contain 60 mass % or less of the pigment when the overall mass of the coating material is 100 mass %.

The thermosetting powder coating material may contain various additive agents as necessary, in addition to the above components. Examples of the additive agents include a surface conditioner, an ultraviolet absorbing agent, an antioxidant, an antistatic agent, a flame retardant, etc.

The coating operation in this step may be performed once or two or more times. That is, after the thermosetting powder coating material is caused to adhere to the surface of the spring member, the thermosetting powder coating material may be repeatedly caused to adhere to the spring member so as to be stacked thereon. For example, two layers of the coating film can be formed by performing the coating operation twice. In the case of performing the coating operation a plurality of times, it is desirable to perform the coating operations successively. The coating operations may use the same kind of thermosetting powder coating material or different kinds of thermosetting powder coating material. For example, in the case where the same kind of resin is contained in the stacked coating films, adhesion between the coating films is increased. Accordingly, the coating films are less likely to be delaminated from each other even when subjected to a large amount of distortion specific to spring members. Moreover, high conformity to deformation of the spring member is achieved.

(3) Curing Step

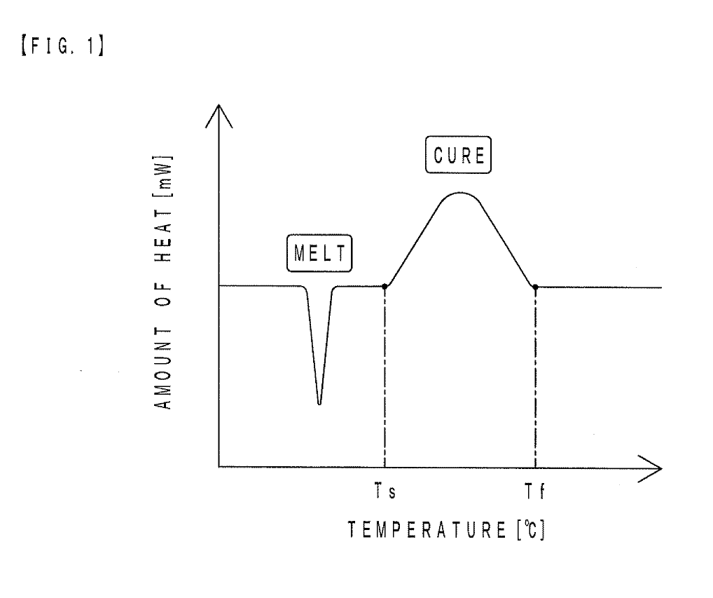

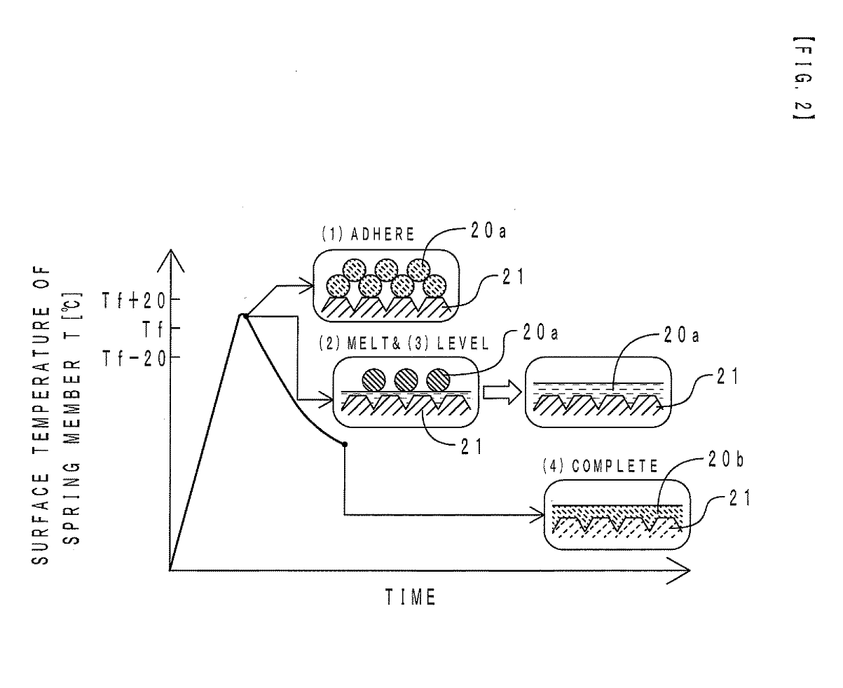

This step is the step of curing the thermosetting powder coating material adhering to the surface of the spring member. In principle, curing of the thermosetting powder coating material can be performed while the spring member is allowed to stand to cool. That is, the thermosetting powder coating material can be cured by the remaining heat of the spring member. In order to sufficiently cure the thermosetting powder coating material, it is desired that the surface temperature T (° C.) of the spring member upon completion of the curing be “Tₛ+30≦T” (Tₛ: curing start temperature (° C.) of the thermosetting powder coating material). This is because the curing is less likely to proceed if the surface temperature of the spring member is less than (Tₛ+30)° C. Accordingly, if the surface temperature of the spring member becomes less than (Tₛ+30)° C. before the curing is completed, it is desirable to heat the spring member again to increase the surface temperature of the spring member. That is, it is desirable to further heat the spring member in this step to cure the thermosetting powder coating material. As shown in FIG. 1, the curing start temperature Tₛ can be obtained by DSC.

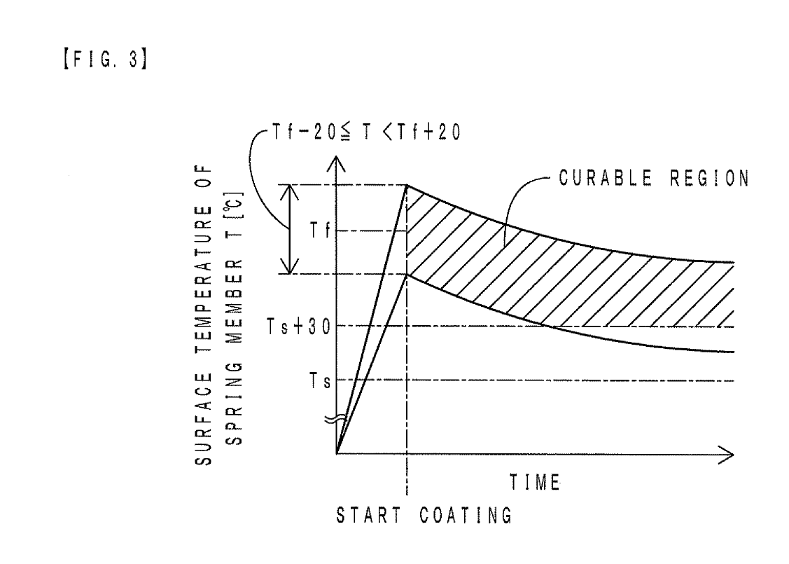

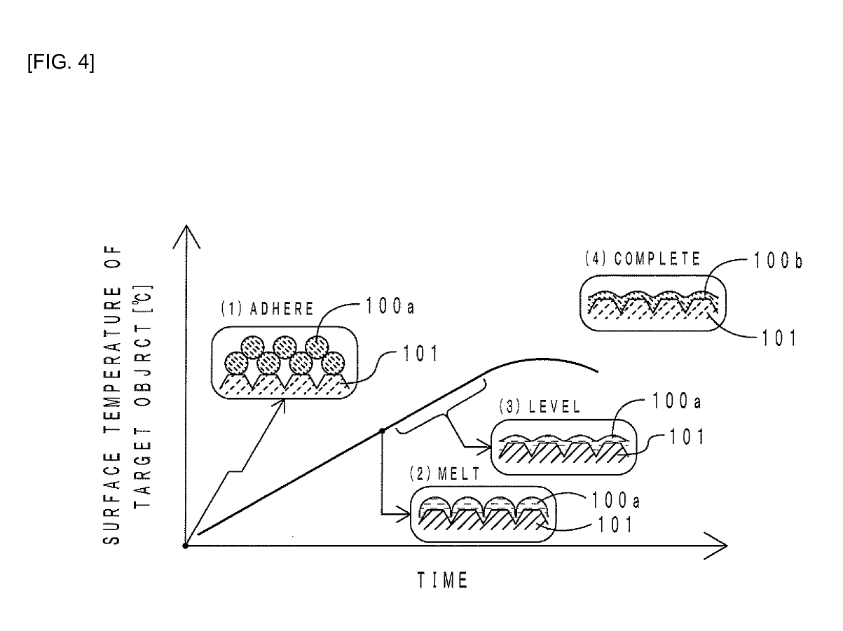

FIG. 3 schematically shows a change in surface temperature of the spring member with time in the powder coating method of the present invention. As shown in FIG. 3, the spring member is heated, and the coating operation is started while the surface temperature T (° C.) of the spring member is in the range of “T_{f}−20≦T<T_{f}+20.” After the coating operation is started, the surface temperature of the spring member falls with time as the spring member is allowed to stand to cool. It is desirable to perform the curing in a curable region shown as a hatched region in the figure. In other words, it is desirable to complete the curing while the surface temperature of the spring member is (Tₛ+30)° C. or more.

Although it depends on the surface temperature of the spring member at the time when the coating operation is started, the thickness of the coating film, or the like, the thermosetting powder coating material can be sufficiently cured if the surface temperature of the spring member 180 seconds after the start of the coating operation is (Tₛ+30)° C. or more, for example.

The degree of curing can be checked by measuring the gelling ratio of the coating film. The gelling ratio is a mass fraction of an extracted insoluble matter to a solvent such as acetone or xylene. For example, after a part of the coating film (a sample) is immersed in a solvent for a predetermined time, the sample is dried, and mass of the sample is measured. The gelling ratio is calculated by the following expression (I).

Gelling ratio (%)=dry mass of sample after immersion in solvent/mass of sample before immersion in solvent×100 (I)

The more the curing proceeds, the higher the gelling ratio is. For example, if the gelling ratio is 90% or more, it can be determined that the curing has sufficiently proceeded.

After the curing of the thermosetting powder coating material is completed, it is desirable to rapidly cool the coating film to a temperature less than the melting temperature of the thermosetting powder coating material, in order to maintain quality of the coating film surface and to facilitate handling. That is, the powder coating method of the present invention can be configured to include a rapid cooling step of rapidly cooling the coating film after this step. The coating film may be rapidly cooled by air blast, mist, shower, dipping, etc.

### Example

The present invention will be more specifically described by using an example.

<Examination of Coating Start Temperature>

(1) Coating with Epoxy/Polyester Powder Coating Material

First, the surface of a steel pipe (material: STKM13A, outer diameter: φ23 mm, thickness: 6 mm, and length: 200 mm) was subjected to shot peening. Next, a zinc phosphate film was formed on the surface by a spray method. Then, the steel pipe was heated in an air-heating furnace, and subsequently, was removed therefrom. The surface temperature of the steel pipe was measured with a thermocouple. When the surface temperature reached a predetermined temperature, an epoxy/polyester powder coating material was caused to adhere to the surface of the steel pipe by using a corona-charging coating gun. At this time, the thickness of the coating film was adjusted to 60 to 100 μm. Thereafter, the epoxy/polyester powder coating material was cured with no heating.

The epoxy/polyester powder coating material primarily contains an epoxy resin, a polyester resin, and an extender (calcium carbonate). The curing start temperature (Tₛ) and the curing completion temperature (T_{f}) of the epoxy/polyester powder coating material were obtained by DSC (heat-up conditions: 10° C./min). As a result, Tₛ=111.7° C. and T_{f}=195.0° C. Thus, Tₛ+30=141.7° C., T_{f}−20° C.=175.0° C., and T_{f}+20=215.0° C.

Appearance of the obtained coating film was visually observed to evaluate the condition of the coating film surface. The gelling ratio of the coating film was also measured. That is, a part of the coating film was first scraped off as a sample, and mass of the sample was measured. Next, the sample was immersed in acetone for 3 hours. Thereafter, the sample after immersion was dried to measure the mass. The gelling ratio was calculated from the mass before and after the immersion in acetone by using the expression (I). The coating film was evaluated based on the surface condition and the gelling ratio of the coating film. The results are shown in Table 1. In the section “Evaluation” in Table 1, “◯” represents samples having a gelling ratio of 90% or more and a satisfactory surface condition, and “X” represents the other samples.

TABLE 1

| Sample No. | 1-1 | 1-2 | 1-3 | 1-4 | 1-5 |
|---|---|---|---|---|---|
| Coating Start Temperature [° C.] | 160 | 180 | 200 | 220 | 240 |
| Gelling Ratio [%] | 82 | 90 | 91 | 93 | 98 |
| Coating Film Surface Condition | Satisfactory | Satisfactory | Satisfactory | Orange Peel | Burnt |
| Evaluation | x | ∘ | ∘ | x | x |

As shown in Table 1, for samples 1-2, 1-3, coating was started in the range of “T_{f}−20≦T<T_{f}+20,” namely when the surface temperature of the steel pipe was 175.0° C. or more and less than 215.0° C., and these samples 1-2, 1-3 each had a gelling ratio of 90% or more and a satisfactory surface condition. That is, curing had sufficiently proceeded, and the coating film surface was smooth and was not waved so much. On the other hand, for sample 1-1, coating was started when the surface temperature of the steel pipe was less than 175.0° C. This sample 1-1 had a satisfactory surface condition, but had a low gelling ratio, and curing had not sufficiently proceeded. This is because the coating start temperature was low and also the surface temperature of the steel pipe became less than 141.7° C. (Tₛ+30° C.) before completion of curing. For samples 1-4, 1-5, coating was started when the surface temperature of the steel pipe was 215.0° C. or more, and these samples 1-4, 1-5 each had a high gelling ratio, but a poor surface condition. That is, the coating film surface became rough because the coating start temperature was too high.

(2) Coating with Epoxy Powder Coating Material

A steel pipe similar to that in the above (1) (a zinc phosphate film was formed after a shot peening process) was coated with an epoxy powder coating material. First, the steel pipe was heated in an air-heating furnace, and then, was removed therefrom. Next, the surface temperature of the steel pipe was measured with a thermocouple. When the surface temperature reached a predetermined temperature, an epoxy powder coating material was caused to adhere to the surface of the steel pipe by using a corona-charging coating gun. At this time, the thickness of the coating film was adjusted to 60 to 100 μm. Thereafter, the epoxy powder coating material was cured with no heating.

The epoxy powder coating material primarily contains an epoxy resin, a curing agent, and an extender (calcium carbonate). The curing start temperature (T₈) and the curing completion temperature (T_{f}) of the epoxy powder coating material were obtained by DSC (heat-up conditions: 10° C./min). As a result, Tₛ=105.0° C. and T_{f}=174.9° C. Thus, Tₛ+30=135.0° C., T_{f}−20° C.=154.9° C., and T_{f}+20=194.9° C.

Appearance of the obtained coating film was visually observed to evaluate the condition of the coating film surface. The gelling ratio of the coating film was also measured in a manner similar to that of the above (1). The coating film was evaluated based on the surface condition and the gelling ratio of the coating film. The results are shown in Table 2. In the section “Evaluation” in Table 2, “◯” represents samples having a gelling ratio of 90% or more and a satisfactory surface condition, and “x” represents the other samples.

TABLE 2

| Sample No. | 2-1 | 2-2 | 2-3 | 2-4 | 2-5 |
|---|---|---|---|---|---|
| Coating Start Temperature [° C.] | 140 | 160 | 180 | 200 | 220 |
| Gelling Ratio [%] | 85 | 95 | 98 | 99 | 99 |
| Coating Film Surface Condition | Satisfactory | Satisfactory | Satisfactory | Orange Peel | Orange Peel |
| Evaluation | x | ∘ | ∘ | x | x |

As shown in Table 2, for samples 2-2, 2-3, coating was started in the range of “T_{f}−20≦T<T_{f}+20,” namely when the surface temperature of the steel pipe was 154.9° C. or more and less than 194.9° C., and these samples 2-2, 2-3 each had a gelling ratio of 90% or more and a satisfactory surface condition. That is, curing had sufficiently proceeded, and the coating film surface was smooth and was not waved so much. On the other hand, for sample 2-1, coating was started when the surface temperature of the steel pipe was less than 154.9° C. This sample 2-1 had a satisfactory surface condition, but had a low gelling ratio, and curing had not sufficiently proceeded. This is because the coating start temperature was low and also the surface temperature of the steel pipe became less than 135.0° C. (Tₛ+30° C.) before completion of curing. For samples 2-4, 2-5, coating was started when the surface temperature of the steel pipe was 194.9° C. or more, and these samples 2-4, 2-5 each had a high gelling ratio, but a poor surface condition. That is, the coating film surface became rough because the coating start temperature was too high.

As described above, it was confirmed that a coating film having a smooth coating film surface and good appearance can be formed if coating with a thermosetting powder coating was started when the surface temperature T of the steel pipe is in the range of “T_{f}−20≦T<T_{f}+20.”

### <Adhesion of Coating Film>

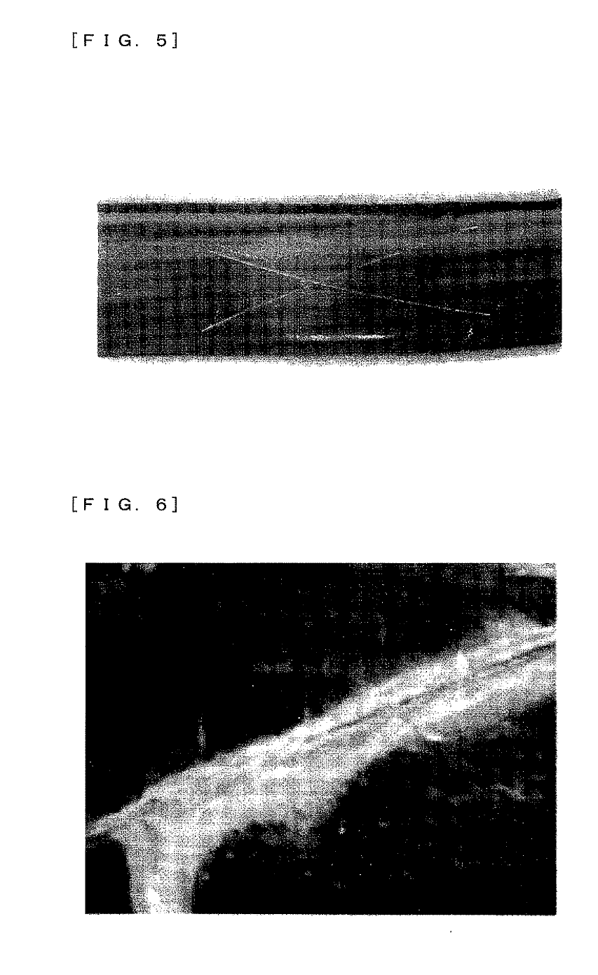

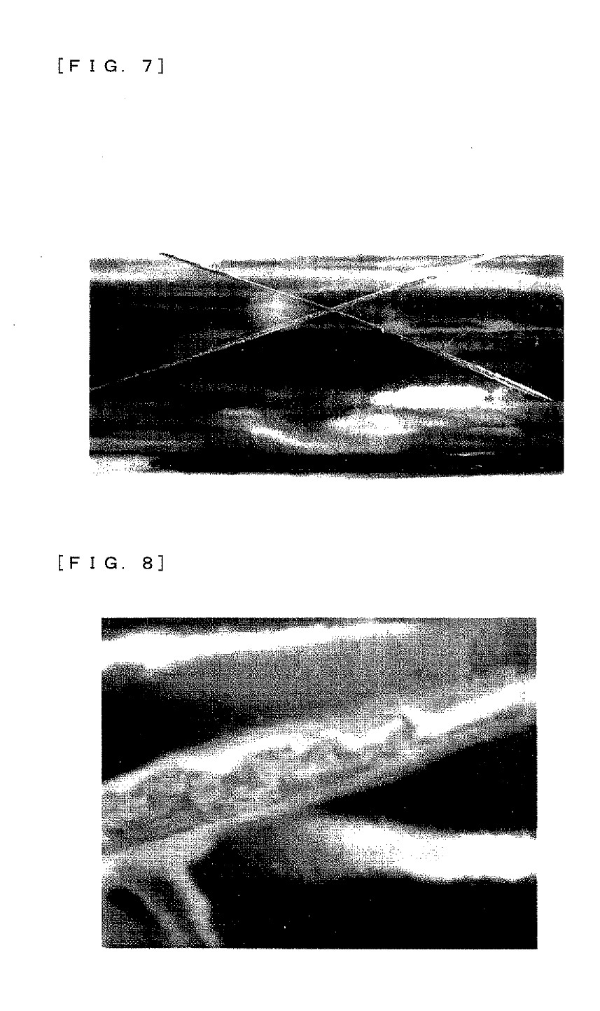

A corrosion resistance test was conducted to evaluate adhesion of the coating film made of the epoxy/polyester powder coating material (the sample 1-3, hereinafter referred to as the “coating film of the example”). The corrosion resistance test was conducted according to 4.6 “Corrosion Resistance Test Method” of JIS D 0202 (1988). The test time of a salt spray test was 720 hours. For comparison, the corrosion resistance test was also conducted to evaluate adhesion of a coating film formed by using the same powder coating material but by the conventional powder coating method (heating and curing the coating material after adhesion of the coating material) (hereinafter referred to as the “coating film of the comparative example”). FIG. 5 shows an image of the coating film of the example before the salt spray test. FIG. 6 shows an enlarged image of a rusted part of the coating film surface of the example after 720 hours of the salt spray test. FIG. 7 shows an image of the coating film of the comparative example before the salt spray test. FIG. 8 shows an enlarged image of a rusted part of the coating film surface of the comparative example after 720 hours of the salt spray test.

As shown in FIGS. 6 and 8, after the salt spray test, red rust was produced in both coating films of the example and the comparative example. However, the width of the rusted part in the coating film of the example was about ½ of that of the rusted part of the coating film of the comparative example. No bulge was observed in the coating film of the example. The results show the fact that the coating film of the example has an adhesion higher than that of the coating film of the comparative example.

As described above, it was confirmed that a coating film having high adhesion can be formed according to the powder coating method of the present invention.

1. A powder coating method, comprising:
a heating step of heating a spring member;
a coating step of causing a thermosetting powder coating material to adhere to a surface of the spring member, with a surface temperature T (° C.) of the spring member being in a range of “T_{f}−20≦T<T_{f}+20” (T_{f}: a curing completion temperature (° C.) of the thermosetting powder coating material); and
a curing step of curing the thermosetting powder coating material adhering to the surface of the spring member.

2. The powder coating method according to claim 1, wherein
in the curing step, the surface temperature T (° C.) of the spring member upon completion of the curing is “Tₛ+30≦T” (Tₛ: a curing start temperature (° C.) of the thermosetting powder coating material).

3. The powder coating method according to claim 1, wherein
in the curing step, the thermosetting powder coating material is cured with remaining heat of the spring member.

4. The powder coating method according to claim 1, wherein
in the curing step, the thermosetting powder coating material is cured by further heating.

5. The powder coating method according to claim 1, further comprising: after the curing step, a rapid cooling step of rapidly cooling the coating film.

6. The powder coating method according to claim 5, wherein
the rapid cooling of the coating film is performed by any of air blast, mist, shower, and dipping.

7. The powder coating method according to claim 1, wherein
the thermosetting powder coating material contains an epoxy resin.

8. The powder coating method according to claim 1, wherein
the heating of the spring member in the heating step is performed using any of an air-heating furnace, electrical heating, and induction heating.

9. The powder coating method according to claim 1, further comprising: before the heating step, a pretreatment step of forming in advance a phosphate film on a base surface of the spring member.
